(19) United States
(12) Patent Application Publication
(10) Pub. No.: US 2024/0284414 A1
(43) Pub. Date: Aug. 22, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/648,386

(22) Filed: Apr. 28, 2024

Related U.S. Application Data
(63) Continuation of application No. PCT/CN2022/130484, filed on Nov. 8, 2022.

(30) Foreign Application Priority Data
Nov. 9, 2021 (CN) 202111318059.1

(51) Int. Cl. H04W 72/044; H04L 5/00; H04W 72/232

(52) U.S. Cl. CPC H04W 72/044; H04L 5/0053; H04W 72/232

(57) ABSTRACT

A node first receives a first information block; then receives a first signaling in a first time-frequency resource set and receives a first signal in a second time-frequency resource set; the first information block is used to determine a first time-domain resource pool; the first signaling is used to determine the second time-frequency resource set; a first field comprised in the first signaling is used to determine a first reference signal resource; a time offset between the first signaling and the first signal is a first time offset; the first signal is QCLed with the first reference signal resource or the second reference signal resource; whether the first time-frequency resource set or the second time-frequency resource set belongs to the first time-domain resource pool is used to determine the second reference signal resource. The present application improves the determination of TCI, thus optimizing the system performance under full duplex.

### CROSS REFERENCE TO RELATED APPLICATIONS

This application is the continuation of the international patent application No. PCT/CN2022/130484, filed on Nov. 8, 2022, and claims the priority benefit of Chinese Patent Application No. 202111318059.1, filed on Nov. 9, 2021, the full disclosure of which is incorporated herein by reference.

### BACKGROUND

### Technical Field

The present application relates to transmission methods and devices in wireless communication systems, and in particular to a transmission scheme and device for flexible transmission direction configuration in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. The work item of NR was approved at 3GPP RAN #75th plenary to standardize NR. A Study Item (SI) and a Work Item (WI) of NR Rel-17 was decided to start at 3GPP RAN #86th plenary, and it is anticipated that an SI and WI of NR Rel-18 will be approved at 3GPP RAN #94e-th plenary.

In new radio technology, enhanced Mobile BroadBand (eMBB), Ultra-reliable and Low Latency Communications (URLLC), and massive Machine Type Communications (mMTC) are the three main application scenarios. In NR Rel-16 system, the main difference between Long-Term Evolution (LTE) and LTE-A frame structures is that symbols in a slot can be configured as Downlink, Uplink and Flexible. For symbols configured as “Flexible”, the terminal will receive Downlink on the symbol, and the symbol can also be used for Uplink scheduling. The above method is more flexible than LTE and LTE-A systems.

### SUMMARY

In the existing NR system, the base station can dynamically indicate a QCL (Quasi Co-located) relation adopted by a scheduled PDSCH (Physical Downlink Shared Channel) through a TCJ (Transmission Configuration Indication) field in DCI (Downlink control information). However, when ending moments of the scheduled PDSCH and the DCI are too close in time domain, causing the terminal to not have time to adjust the beam direction, the terminal determines a QCL relation of a current PDSCH according to a QCL relation adopted by a CORESET (Control Resource Set) with a smallest controlResourceSetId in a nearest slot. The above problem of the terminal not being able to adjust the beam direction in time needs to be reconsidered and redesigned in operating scenarios that support flexible duplex modes.

The present application discloses a solution to the problem of supporting the configuration of link direction in flexible duplex mode. It should be noted that in the description of the application, flexible duplex mode is only used as a typical application scenario or example; the application is also applicable to other scenarios confronting similar problems (such as scenarios where link direction changes, or other scenarios that support multi-level configuration of the transmission direction, or base stations or UE with stronger capabilities, such as scenarios supporting full duplex on a same frequency, or different application scenarios, such as eMBB and URLLC), where similar technical effects can be achieved. Additionally, the adoption of a unified solution for various scenarios, including but not limited to scenarios of eMBB and URLLC, contributes to the reduction of hardware complexity and costs. If no conflict is incurred, embodiments in a first node in the present application and characteristics of the embodiments are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first information block; and
receiving a first signaling in a first time-frequency resource set, and receiving a first signal in a second time-frequency resource set;
herein, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed (Quasi Co-Located) with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, one technical feature of the above method is in: while ensuring the flexibility of the system implementation, the overall performance of the system can also be improved.

In one embodiment, another technical feature of the above method is in: limiting a default TCI adopted by the terminal for the first signal to time-domain resources occupied by the first signaling or time-domain resources of a same type as time-domain resources occupied by the first signal, that is, to the first time-domain resource pool, so as to ensure the accuracy of the default TCI.

According to one aspect of the present application, the first node monitors one or multiple CORESETs (control resource sets) in an active BWP (bandwidth part) of a serving cell it monitors; the first time offset is less than the first threshold; when time-domain resources occupied by the first time-frequency resource set belong to the first time-domain resource pool, the second reference signal resource is related to QCL parameters of a PDCCH (Physical Downlink Control Channel) QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

In one embodiment, one technical feature of the above method is in: a default TCI of a data channel scheduled by a PDCCH located in full duplex resources can only refer to a TCI adopted by a CORESET located in full duplex resources, while a default TCI of a data channel scheduled by a PDCCH located outside the full duplex resources can only refer to a TCI adopted by a CORESET located outside the full duplex resources.

According to one aspect of the present application, the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH (Physical Downlink Control Channel) QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

In one embodiment, one technical feature of the above method is in: the default TCJ of a data channel scheduled by a PDCCH located in full duplex resources can only refer to a TCJ adopted by a CORESET located in full duplex resources, while the selection of a default TCJ of a data channel scheduled by a PDCCH outside of full duplex resources follows the existing standard approach.

According to one aspect of the present application, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

In one embodiment, one technical feature of the above method is in: a default TC of a data channel located in full duplex resources can only refer to a TCJ adopted by a CORESET located in full duplex resources, while a default TCI of a data channel located outside of full duplex resources can only refer to a TCI adopted by a CORESET located outside full duplex resources.

According to one aspect of the present application, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

In one embodiment, one technical feature of the above method is in: a default TCI for a data channel located in full duplex resources can only refer to a TCI adopted by a CORESET located in full duplex resources, while the selection of the default TCI for the data channel located outside full duplex resources follows the existing standard approach.

According to one aspect of the present application, a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

According to one aspect of the present application, comprising:
receiving a second information block and a third information block;
herein, the second information block is used to indicate QCL parameters corresponding to a PDCCH QCL indication of the first control resource set, and the third information block is used to indicate QCL parameters corresponding to a PDCCH QCL indication of the second CORESET.

According to one aspect of the present application, frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

The present application provides a method in a second node for wireless communications, comprising:
transmitting a first information block; and
transmitting a first signaling in a first time-frequency resource set, and transmitting a first signal in a second time-frequency resource set;
herein, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

According to one aspect of the present application, a receiver of the first information block comprises a first node; the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

According to one aspect of the present application, a receiver of the first information block comprises a first node; the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

According to one aspect of the present application, a receiver of the first information block comprises a first node; the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

According to one aspect of the present application, a receiver of the first information block comprises a first node; the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

According to one aspect of the present application, a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

According to one aspect of the present application, comprising:
transmitting a second information block and a third information block;
herein, the second information block is used to indicate QCL parameters corresponding to a PDCCH QCL indication of the first control resource set, and the third information block is used to indicate QCL parameters corresponding to a PDCCH QCL indication of the second CORESET.

According to one aspect of the present application, frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

The present application provides a first node for wireless communications, comprising:
a first receiver, receiving a first information block; and
a second receiver, receiving a first signaling in a first time-frequency resource set, receiving a first signal in a second time-frequency resource set;
herein, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

The present application provides a second node for wireless communications, comprising:
a first transmitter, transmitting a first information block; and
a second transmitter, transmitting a first signaling in a first time-frequency resource set, and transmitting a first signal in a second time-frequency resource set;
herein, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first information block according to one embodiment of the present application;

FIG. 6 illustrates a flowchart of a second information block and a third information block according to one embodiment of the present application;

FIG. 7 illustrates a schematic diagram of a first signaling and a first signal according to one embodiment of the present application;

FIG. 8 illustrates a schematic diagram of a first time-domain resource pool according to one embodiment of the present application;

FIG. 9 illustrates a schematic diagram of a first control resource set according to one embodiment of the present application;

FIG. 10 illustrates a schematic diagram of a second control resource set according to one embodiment of the present application;

FIG. 11 illustrates a schematic diagram of a first control resource set according to another one embodiment of the present application;

FIG. 12 illustrates a schematic diagram of a second control resource set according to another embodiment of the present application;

FIG. 13 illustrates a schematic diagram a first frequency-domain resource set and a second frequency-domain resource set according to another embodiment of the present application;

FIG. 14 illustrates a structure block diagram of a processor in a first node according to one embodiment of the present application;

FIG. 15 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

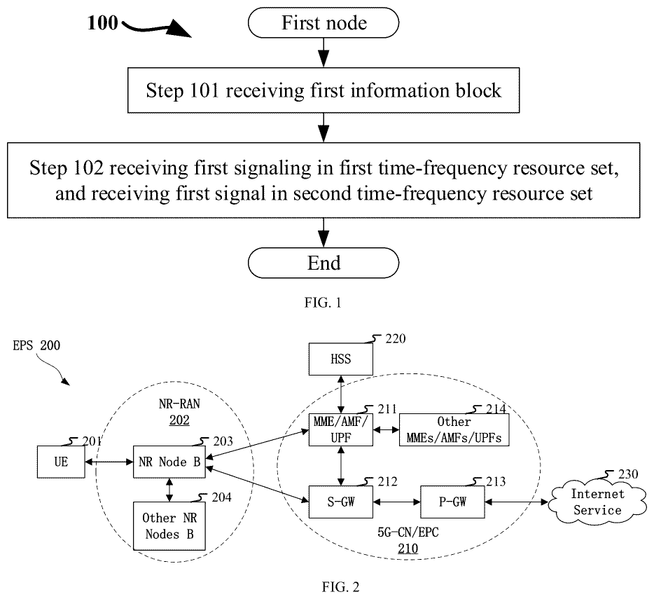

Embodiment 1 illustrates a processing flowchart of a first node, as shown in FIG. 1. In step 100 illustrated by FIG. 1, each box represents a step. In Embodiment 1, a first node in the present application receives a first information block in step 101; receives a first signaling in a first time-frequency resource set in step 102, and receives a first signal in a second time-frequency resource set.

In embodiment 1, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the first information block is used to explicitly indicate the first time-domain resource pool.

In one embodiment, the first information block is used to implicitly indicate the first time-domain resource pool.

In one embodiment, the first information block is transmitted through a Radio Resource Control (RRC) signaling.

In one embodiment, the first information block is transmitted through a Medium Access Control (MAC) Control Element (CE).

In one embodiment, the first information block is transmitted through a PDCCH.

In one embodiment, a name of an RRC signaling or a MAC CE used for transmitting the first information block comprises at least one of “Slot” or “Format”.

In one embodiment, a name of an RRC signaling or a MAC CE used for transmitting the first information block comprises “SFI”.

In one embodiment, a name of an RRC signaling or a MAC CE used for transmitting the first information block comprises “Combination”.

In one embodiment, the first time-frequency resource set is associated with a CORESET.

In one embodiment, the first time-frequency resource set is all REs (Resource Elements) occupied by a CORESET in a slot.

In one embodiment, the first time-frequency resource set is associated with a search space set.

In one embodiment, the first time-frequency resource set is associated with a search space.

In one embodiment, the first time-frequency resource set is a CORESET.

In one embodiment, frequency-domain resources occupied by the first time-frequency resource set are equal to frequency-domain resources occupied by its associated CORESET.

In one embodiment, time-domain resources occupied by the first time-frequency resource set in a slot are equal to time-domain resources occupied by its associated CORESET.

In one embodiment, a slot where the first time-frequency resource set is located is one of all slots occupied by its associated search space set.

In one embodiment, a slot where the first time-frequency resource set is located is one of all slots occupied by its associated search space.

In one embodiment, a physical-layer channel occupied by the first signaling comprises a PDCCH.

In one embodiment, the first signaling is a PDCCH.

In one embodiment, the first signaling is DCI.

In one embodiment, the first signaling is used to schedule the first signal.

In one embodiment, the first signaling is a DL Grant.

In one embodiment, the first signaling is used to indicate time-domain resources occupied by the second time-frequency resource set.

In one embodiment, the first signaling is used to indicate frequency-domain resources occupied by the second time-frequency resource set.

In one embodiment, the first signaling is used to indicate time-frequency resources occupied by the second time-frequency resource set.

In one embodiment, the first signaling occupies a PDCCH candidate in the first time-frequency resource set.

In one embodiment, the first signaling occupies multiple PDCCH candidates in the first time-frequency resource set.

In one embodiment, the second time-frequency resource set occupies more than one positive integer number of REs in time domain.

In one embodiment, the first signal is a radio signal.

In one embodiment, the first signal is a baseband signal.

In one embodiment, a physical-layer channel occupied by the first signal comprises a Physical Downlink Shared Channel (PDSCH).

In one embodiment, the first signal is generated through a transmission block.

In one embodiment, the first time-domain resource pool comprises more than one positive integer number of slots in time domain.

In one embodiment, the first time-domain resource pool comprises more than one positive integer number of multicarrier symbols in time domain.

In one embodiment, multiple slots comprised in the first time-domain resource pool are discrete in time domain.

In one embodiment, multiple multicarrier symbols comprised in the first time-domain resource pool are discrete in time domain.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multicarrier (FBMC) symbol.

In one embodiment, the multicarrier symbol comprises a Cyclic Prefix (CP).

In one embodiment, the first field comprised in the first signaling is a TCI field.

In one embodiment, the first field comprised in the first signaling is used to indicate QCL parameters of the first signal.

In one embodiment, the first field comprised in the first signaling is used to indicate a QCL relation of the first signal.

In one embodiment, the first reference signal resource comprises Channel-State Information Reference Signal (CSI-RS) resources.

In one embodiment, the first reference signal resource comprises an SS/PBCH Block (SSB).

In one embodiment, the first reference signal resource corresponds to a TCI.

In one embodiment, the first reference signal resource corresponds to a TCI-State.

In one embodiment, the first reference signal resource corresponds to a TCI-StateId.

In one embodiment, the first time offset is measured by multicarrier symbol.

In one embodiment, the first time offset is equal to a number of positive integer number of multicarrier symbol(s).

In one embodiment, a subcarrier interval referenced by the first time offset value is equal to 60 KHz (kilohertz) or 120 KHz.

In one embodiment, the first time offset is measured by ms.

In one embodiment, the first time offset is equal to X milliseconds, and X is a real number greater than 1.

In one embodiment, the first time offset is measured by slot.

In one embodiment, the first time offset is equal to Y slots, and Y is a real number greater than 1.

In one embodiment, the first time offset value is related to a subcarrier spacing adopted by the first signal.

In one embodiment, the first time offset value is related to a subcarrier spacing adopted by the first signaling.

In one embodiment, the first time offset is a time deviation between a starting time of the first signaling and a starting time of the first signal.

In one embodiment, the first time offset is a time deviation between an end time of the first signaling and a starting time of the first signal.

In one embodiment, a first moment is a moment in time-domain resources occupied by the first signal, and a second moment is a moment in time-domain resources occupied by the first signaling, and the first time offset is a time deviation between the first moment and the second moment.

In one embodiment, the first time offset is a difference between a starting symbol index of the first signal and a starting symbol index of the first signaling.

In one embodiment, the first time offset is a difference between a starting symbol index of the first signal and an end symbol index of the first signaling.

In one embodiment, the first time offset is a difference between a starting slot index of the first signal and an end slot index of the first signaling.

In one embodiment, a time deviation between two moments is equal to a difference value obtained by subtracting an earlier one of the two moments from a later one of the two moments.

In one embodiment, a time deviation between two moments is equal to an absolute value of a difference between the two moments.

In one embodiment, the first threshold is reported by the first node to a transmitter of the first signaling.

In one embodiment, the first threshold is based on a reported capability of the first node.

In one embodiment, the first threshold is indicated by a timeDurationForQCL parameter.

In one embodiment, a name of a parameter indicating the first threshold comprises timeDurationForQCL.

In one embodiment, a name of a parameter indicating the first threshold comprises Duration.

In one embodiment, a name of a parameter indicating the first threshold comprises time.

In one embodiment, a name of a parameter indicating the first threshold comprises QCL.

In one embodiment, the first threshold is measured by symbol.

In one embodiment, the first threshold is measured by millisecond.

In one embodiment, for specific definition of the timeDurationForQCL, refer to section 5.1.5 of 3GPP TS38.214.

In one embodiment, the first threshold is indicated by a FeatureSetDownlink IE (Information Element).

In one embodiment, the first threshold is indicated by a UE capability IE.

In one embodiment, for specific definitions of the FeatureSetDownlink IE and the UE capability IE, refer to section 6.3.3 of 3GPP TS38.331.

In one embodiment, the first threshold is configured through a higher-layer signaling.

In one embodiment, the first threshold is configured through an RRC signaling.

In one embodiment, the second reference signal resource comprises Channel-State Information Reference Signal (CSI-RS) resources.

In one embodiment, the second reference signal resource comprises an SS/PBCH Block (SSB).

In one embodiment, the second reference signal resource corresponds to a TCI.

In one embodiment, the second reference signal resource corresponds to a TCI-State.

In one embodiment, the second reference signal resource corresponds to a TCI-StateId.

In one embodiment, the first reference signal resource is different from the second reference signal resource.

In one embodiment, the first reference signal resource is the same as the second reference signal resource.

In one embodiment, the second reference signal resource is unrelated to the first reference signal resource.

In one embodiment, the first time-frequency resource set is used to determine a scrambling of a CRC comprised in the first signaling.

In one subembodiment of the embodiment, when time-domain resources occupied by the first time-frequency resource set belong to the first time-domain resource pool, a CRC (Cyclic Redundancy Check) comprised in the first signaling passes a scrambling of a first identity; when time-domain resources occupied by the first time-frequency resource set do not belong to the first time-domain resource pool, a CRC comprised in the first signaling is scrambled through a second identity; the first identity and the second identity are different, and both of the first identity and the second identity are non-negative integers.

In one embodiment, the QCL refers to Quasi Co-Located.

In one embodiment, the QCL refers to Quasi Co-Location.

In one embodiment, the QCL comprises a QCL parameter.

In one embodiment, the QCL comprises a QCL assumption.

In one embodiment, a type of the QCL comprises QCL-TypeA.

In one embodiment, a type of the QCL comprises QCL-TypeB.

In one embodiment, a type of the QCL comprises QCL-TypeC.

In one embodiment, a type of the QCL comprises QCL-TypeD.

In one embodiment, the meaning of the above phrase that a demodulation reference signal of a channel occupied by the first signal and the first reference signal resource are QCL comprises: the first signal and a reference signal transmitted in the first reference signal resource use same QCL parameters.

In one embodiment, the meaning of the above phrase that a demodulation reference signal of a channel occupied by the first signal and the first reference signal resource are QCL comprises: the demodulation reference signal of a channel occupied by the first signal and a reference signal transmitted in the first reference signal resource use same QCL parameters.

In one embodiment, the meaning of the above phrase that a demodulation reference signal of a channel occupied by the first signal and the first reference signal resource are QCL comprises: the first node assumes that the first signal and a reference signal transmitted in the first reference signal resource use same QCL parameters.

In one embodiment, the meaning of the above phrase that a demodulation reference signal of a channel occupied by the first signal and the first reference signal resource are QCL comprises: the first node adopts same QCL parameters to receive the first signal and a reference signal transmitted in the first reference signal resource.

In one embodiment, the meaning of the above phrase that a demodulation reference signal of a channel occupied by the first signal and the first reference signal resource are QCL comprises: the first node assumes that a QCL assumption of the first signal is the same as a QCL assumption of a reference signal transmitted in the first reference signal resource.

In one embodiment, the meaning of the above phrase that a demodulation reference signal of a channel occupied by the first signal and the first reference signal resource are QCL comprises: the first signal and a reference signal transmitted in the first reference signal resource use same spatial Rx parameters.

In one embodiment, the meaning of the above phrase that a demodulation reference signal of a channel occupied by the first signal and the first reference signal resource are QCL comprises: the first node assumes that the first signal and a reference signal transmitted in the first reference signal resource use same spatial Rx parameters.

In one embodiment, the meaning of the above phrase that a demodulation reference signal of a channel occupied by the first signal and the first reference signal resource are QCL comprises: the first node adopts same spatial reception parameters to receive the first signal and a reference signal transmitted in the first reference signal resource.

In one embodiment, the meaning of the above phrase that a demodulation reference signal of a channel occupied by the first signal and the second reference signal resource are QCL comprises: the first signal and a reference signal transmitted in the second reference signal resource adopt same QCL parameters.

In one embodiment, the meaning of the above phrase that a demodulation reference signal of a channel occupied by the first signal and the second reference signal resource are QCL comprises: the demodulation reference signal of a channel occupied by the first signal and a reference signal transmitted in the second reference signal resource adopt same QCL parameters.

In one embodiment, the meaning of the above phrase that a demodulation reference signal of a channel occupied by the first signal and the second reference signal resource are QCL comprises: the first node assumes that the first signal and a reference signal transmitted in the second reference signal resource adopt same QCL parameters.

In one embodiment, the meaning of the above phrase that a demodulation reference signal of a channel occupied by the first signal and the second reference signal resource are QCL comprises: the first node adopts same QCL parameters to receive the first signal and a reference signal transmitted in the second reference signal resource.

In one embodiment, the meaning of the above phrase that a demodulation reference signal of a channel occupied by the first signal and the second reference signal resource are QCL comprises: the first node assumes that a QCL assumption of the first signal is the same as a QCL assumption of a reference signal transmitted in the second reference signal resource.

In one embodiment, the meaning of the above phrase that a demodulation reference signal of a channel occupied by the first signal and the second reference signal resource are QCL comprises: the first signal and a reference signal transmitted in the second reference signal resource adopt same reception parameters.

In one embodiment, the meaning of the above phrase that a demodulation reference signal of a channel occupied by the first signal and the second reference signal resource are QCL comprises: the first node assumes that the first signal and a reference signal transmitted in the second reference signal resource adopt same spatial reception parameters.

In one embodiment, the meaning of the above phrase that a demodulation reference signal of a channel occupied by the first signal and the second reference signal resource are QCL comprises: the first node adopts same spatial reception parameters to receive the first signal and a reference signal transmitted in the second reference signal resource.

In one embodiment, the QCL TypeA comprises Doppler shift, Doppler spread, average delay, and delay spread.

In one embodiment, the QCL TypeB comprises Doppler shift and Doppler spread.

In one embodiment, the QCL TypeC comprises Doppler shift and average delay.

In one embodiment, the QCL-TypeD comprises Spatial Rx parameters.

In one embodiment, the QCL parameters comprise at least one of delay spread, Doppler spread, Doppler shift, average delay, Spatial Tx parameters or Spatial Rx parameters.

In one embodiment, the Spatial Tx parameters comprise at least one of a transmitting antenna port, a transmitting antenna port group, a transmitting beam, a transmitting analog beamforming matrix, a transmitting analog beamforming vector, a transmitting beamforming matrix, a transmitting beamforming vector and a spatial-domain transmission filter.

In one embodiment, the Spatial Rx parameters comprise at least one of a receiving beam, a receiving analog beamforming matrix, a receiving analog beamforming vector, a receiving beamforming matrix, a receiving beamforming vector and a spatial-domain reception filter.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports Unpaired Spectrum scenario.

In one embodiment, the UE 201 supports Flexible Duplex frequency-domain resource configuration.

In one embodiment, the UE 201 supports Full Duplex transmission.

In one embodiment, the UE 201 supports dynamically adjusting uplink and downlink transmission directions.

In one embodiment, the UE 201 supports a reception method based on beamforming.

In one embodiment, the gNB 203 corresponds to the second node in the present application.

In one embodiment, the gNB 203 supports Unpaired Spectrum scenario.

In one embodiment, the gNB 203 supports Flexible Duplex frequency-domain resource configuration.

In one embodiment, the gNB 203 supports Full Duplex transmission.

In one embodiment, the gNB 203 supports dynamically adjusting uplink and downlink transmission directions.

In one embodiment, the gNB 203 supports beamforming-based transmission method.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first information block is generated by the PHY 301 or the PHY 351.

In one embodiment, the first information block is generated by the MAC 302 or the MAC 352.

In one embodiment, the first information block is generated by the RRC 306.

In one embodiment, the first signaling is generated by the PHY 301 or the PHY 351.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the second information block is generated by the MAC 302 or the MAC 352.

In one embodiment, the second information block is generated by the RRC 306.

In one embodiment, the third information block is generated by the MAC 302 or the MAC 352.

In one embodiment, the third information block is generated by the RRC 306.

In one embodiment, the first node is a terminal.

In one embodiment, the first node is a relay.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

In one embodiment, the second node is a node used for managing multiple carriers.

### Embodiment 4

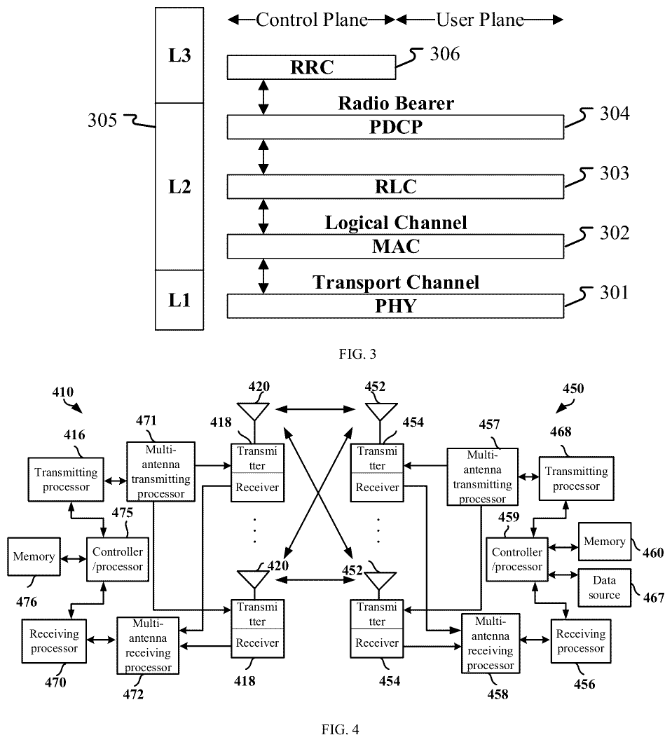

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first information block; then receives a first signaling in a first time-frequency resource set and receives a first signal in a second time-frequency resource set; the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the first communication device 450 comprises at least one processor and at least one memory. a memory that stores a computer readable instruction program. The computer readable instruction program generates an action when executed by at least one processor. The action includes: first receiving a first information block; then receiving a first signaling in a first time-frequency resource set, and receiving a first signal in a second time-frequency resource set; the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first information block; then transmits a first signaling in a first time-frequency resource set, and transmits a first signal in a second time-frequency resource set; the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the second communication device 410 comprises a memory that stores a computer readable instruction program. The computer readable instruction program generates an action when executed by at least one processor. The action includes: first transmitting a first information block; then transmitting a first signaling in a first time-frequency resource set, and transmitting a first signal in a second time-frequency resource set; the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to receive a first signaling in a first time-frequency resource set, and receives a first signal in a second time-frequency resource set; at least first four of the antenna 420, the transmitter 418, the multi-antenna transmitting processor 471, the transmitting processor 416 and the controller/processor 475 are used to transmit a first signaling in a first time-frequency resource set, and transmits a first signal in a second time-frequency resource set.

In one embodiment, at least first four of the antenna 452, the transmitter 454, the multi-antenna transmitting processor 457, the transmitting processor 468, and the controller/processor 459 are used to receive a second information block and a third information block; at least first four of the antenna 420, the receiver 418, the multi-antenna receiving processor 472, the receiving processor 470 and the controller/processor 475 are used to transmit a second information block and a third information block.

### Embodiment 5

Embodiment 5 illustrates a flowchart of a first information block, as shown in FIG. 5. In FIG. 5, a first node U1 and a second node N2 are in communications via a radio link. It is particularly underlined that the order illustrated in the embodiments does not put constraints over sequences of signal transmissions and implementations. Embodiments, sub-embodiments and subsidiary embodiments of embodiment 5 can be applied to embodiment 6 if no conflict is caused. on the contrary, embodiments, sub-embodiments and subsidiary embodiments of embodiments 6 can be applied to embodiment 5 without conflict.

The first node U1 receives a first information block in step S10; receives a first signaling in a first time-frequency resource set in step S11, and receives a first signal in a second time-frequency resource set.

The second node N2 transmits a first information block in step S20; transmits a first signaling in a first time-frequency resource set in step S21, and transmits a first signal in a second time-frequency resource set.

In embodiment 5, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the time unit in the present application is a slot.

In one embodiment, the time unit in the present application is a sub-slot.

In one embodiment, the time unit in the present application is a mini-slot.

In one embodiment, the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest to the first signal in time domain in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being closest to the first signal in time domain outside the first time-domain resource pool.

In one subembodiment of the embodiment, frequency-domain resources occupied by the first time-frequency resource set belong to frequency-domain resources corresponding to the first node in its monitored serving cell.

In one subembodiment of the embodiment, frequency-domain resources occupied by the first time-frequency resource set belong to frequency-domain resources corresponding to the first node in the Active BWP in its monitored serving cell.

In one subembodiment of the embodiment, frequency-domain resources occupied by the second time-frequency resource set belong to frequency-domain resources corresponding to the first node in its monitored serving cell.

In one subembodiment of the embodiment, frequency-domain resources occupied by the second time-frequency resource set belong to frequency-domain resources corresponding to the first node in the active BWP in its monitored serving cell.

In one subembodiment of the embodiment, a CORESET associated with the first time-frequency resource set is a control resource set monitored by the first node in the active BWP of the serving cell.

In one subembodiment of the embodiment, a CORESET associated with the first time-frequency resource set is one of the multiple control resource sets monitored by the first node in the active BWP of the serving cell.

In one subembodiment of the embodiment, when time-domain resources occupied by the first time-frequency resource set belong to the first time-domain resource pool, the second reference signal resource is QCLed with a demodulation reference signal of a PDCCH transmitted in the first control resource set.

In one subembodiment of the embodiment, when time-domain resources occupied by the first time-frequency resource set belong to the first time-domain resource pool, a TCI state associated with the first control resource set is used to determine a QCL relation of the second reference signal resource.

In one subembodiment of the embodiment, when time-domain resources occupied by the first time-frequency resource set belong to the first time-domain resource pool, a TCI state activated by a MAC CE in TCI states associated with the first control resource set is used to determine a QCL relation of the second reference signal resource.

In one subembodiment of the embodiment, the meaning of the above phrase of monitored search space comprises: all search spaces configured for the first node.

In one subembodiment of the embodiment, the meaning of the above phrase of monitored search space comprises: all search space sets configured for the first node.

In one subembodiment of the embodiment, the smallest index is ControlResourceSetId.

In one subembodiment of the embodiment, the smallest index is a non-negative integer.

In one subembodiment of the embodiment, the first time unit comprises multiple CORESETs, and any CORESET in the multiple CORESETs is associated with at least one search space set, and the first control resource set is a CORESET among the multiple CORESETs adopting a smallest ControlResourceSetId.

In one subembodiment of the embodiment, the first time unit comprises multiple CORESETs, and any CORESET in the multiple CORESETs is associated with at least one search space, and the first control resource set is a CORESET among the multiple CORESETs adopting a smallest ControlResourceSetId.

In one subembodiment of the embodiment, the first time unit is a slot.

In one subembodiment of the embodiment, the first time unit is a Sub-Slot.

In one subembodiment of the embodiment, the first time unit is a mini-slot.

In one subembodiment of the above embodiment, the first time unit occupies more than one positive integer number of multicarrier symbols.

In one subembodiment of the above embodiment, the meaning of the phrase that the first time unit is a time unit closest to the first signal in time domain in the first time-domain resource pool comprises: the first time-domain resource pool comprises K1 time units, K1 being a positive integer greater than 1, the first time unit is one of the K1 time units satisfying other conditions related to the first time unit in the present application and being closest to a time unit where the first signal is located.

In one subembodiment of the above embodiment, the meaning of the phrase that the first time unit is a time unit closest to the first signal in time domain in the first time-domain resource pool comprises: the first time-domain resource pool comprises K1 time units, K1 being a positive integer greater than 1, the first time unit is one of the K1 time units satisfying other conditions related to the first time unit in the present application and being a latest time unit not later than a time unit where the first signal is located in time domain.

In one subembodiment of the above embodiment, the meaning of the phrase that the first time unit is a time unit closest to the first signal in time domain in the first time-domain resource pool comprises: the first time-domain resource pool comprises K1 time units, K1 being a positive integer greater than 1, the first time unit is one of the K1 time units satisfying other conditions related to the first time unit in the present application and being a latest time unit not earlier than a time unit where the first signal is located in time domain.

In one subembodiment of the embodiment, when time-domain resources occupied by the first time-frequency resource set do not belong to the first time-domain resource pool, the second reference signal resource is QCLed with a demodulation reference signal of a PDCCH transmitted in the second CORESET.

In one subembodiment of the embodiment, when time-domain resources occupied by the first time-frequency resource set do not belong to the first time-domain resource pool, a TCI state associated with the second CORESET is used to determine a QCL relation of the second reference signal resource.

In one subembodiment of the embodiment, when time-domain resources occupied by the first time-frequency resource set do not belong to the first time-domain resource pool, a TCI state activated by a MAC CE in TCI states associated with the second CORESET is used to determine a QCL relation of the second reference signal resource.

In one subembodiment of the embodiment, the second time unit comprises multiple CORESETs, and any CORESET in the multiple CORESETs is at least associated with a search space set, and the second CORESET is a CORESET adopting a smallest ControlResourceSetId among the multiple CORESETs.

In one subembodiment of the embodiment, the second time unit comprises multiple CORESETs, and any CORESET in the multiple CORESETs is at least associated with a search space, and the second CORESET is a CORESET adopting a smallest ControlResourceSetId among the multiple CORESETs.

In one subembodiment of the embodiment, the second time unit is a slot.

In one subembodiment of the embodiment, the second time unit is a sub-slot.

In one subembodiment of the embodiment, the second time unit is a mini-slot.

In one subembodiment of the above embodiment, the second time unit occupies more than one positive integer number of multicarrier symbols.

In one subembodiment of the above embodiment, the meaning of the phrase that the second time unit is a time unit closest to the first signal in time domain outside the first time-domain resource pool comprises: the first time-domain resource pool comprises K1 time units, K1 being a positive integer greater than 1, and the second time unit is a time unit other than the K1 time units satisfying other conditions related to the second time unit in the present application and being closest to a time unit where the first signal is located.

In one subembodiment of the above embodiment, the meaning of the phrase that the second time unit is a time unit closest to the first signal in time domain outside the first time-domain resource pool comprises: the first time-domain resource pool comprises K1 time units, K1 being a positive integer greater than 1, and the second time unit is a time unit other than the K1 time units satisfying other conditions related to the second time unit in the present application and being a latest time unit not later than a time unit where the first signal is located in time domain.

In one subembodiment of the above embodiment, the meaning of the phrase that the second time unit is a time unit closest to the first signal in time domain outside the first time-domain resource pool comprises: the first time-domain resource pool comprises K1 time units, K1 being a positive integer greater than 1, and the second time unit is a time unit other than the K1 time units satisfying other conditions related to the first time unit in the present application and being a latest time unit earlier than a time unit where the first signal is located in time domain.

In one embodiment, the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

In one subembodiment of the above embodiment, the meaning of the phrase of being a time unit closest to the first signal in time domain comprises: the second time unit is a time unit satisfying other conditions related to the second time unit in the present application and being closest to a time unit where the first signal is located in all time units.

In one subembodiment of the above embodiment, the meaning of the phrase of being a time unit closest to the first signal in time domain in the first time-domain resource pool comprises: the second time unit is a time unit satisfying other conditions related to the second time unit in the present application and being a latest time unit not later than a time unit where the first signal is located in all time units.

In one subembodiment of the above embodiment, the meaning of the phrase of being a time unit closest to the first signal in time domain in the first time-domain resource pool comprises: the second time unit is a time unit satisfying other conditions related to the second time unit in the present application and being a latest time unit earlier than a time unit where the first signal is located in all time units.

In one subsidiary embodiment of the above three subembodiments, the all time units are all time units that the first node needs to monitor.

In one subsidiary embodiment of the above three subembodiments, the all time units are all time units used for downlink transmission that the first node needs to monitor.

In one subsidiary embodiment of the above three subembodiments, the all time units are all time units configured to the first node.

In one subsidiary embodiment of the above three subembodiments, the all time units are all time units used for downlink transmission configured to the first node.

In one embodiment, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

In one embodiment, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

In one embodiment, a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

In one subembodiment of the embodiment, the first format is “F”.

In one subembodiment of the embodiment, the first format is “Flexible”.

In one embodiment, frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

In one subembodiment of the embodiment, the first frequency-domain resource set is a BWP.

In one subembodiment of the embodiment, the first frequency-domain resource set is a subband.

In one subembodiment of the embodiment, the first frequency-domain resource set occupies frequency-domain resources corresponding to continuous more than one RB in frequency domain.

In one subembodiment of the embodiment, the first frequency-domain resource set is configured through an RRC signaling.

In one subembodiment of the embodiment, the second frequency-domain resource set is a BWP.

In one subembodiment of the embodiment, the second frequency-domain resource set is a subband.

In one subembodiment of the embodiment, the second frequency-domain resource set occupies frequency-domain resources corresponding to continuous more than one RB in frequency domain.

In one subembodiment of the embodiment, the second frequency-domain resource set is configured through an RRC signaling.

In one subembodiment of the embodiment, the first frequency-domain resource set and the second frequency-domain resource set belong to a same BWP.

In one subembodiment of the embodiment, the first frequency-domain resource set and the second frequency-domain resource set belong to a same carrier.

In one subembodiment of the embodiment, frequency-domain resources occupied by the first frequency-domain resource set and frequency-domain resources occupied by the second frequency-domain resource set are orthogonal in frequency domain.

### Embodiment 6

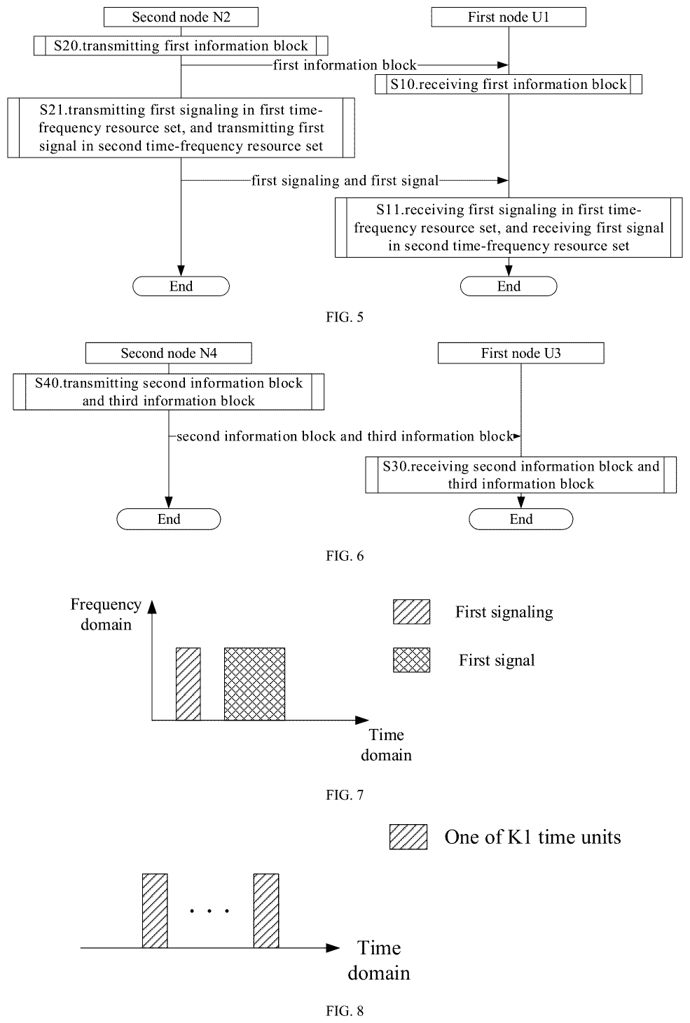

Embodiment 6 illustrates a flowchart of a second information block and a third information block, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to embodiment 5 if no conflict is caused; on the contrary, embodiments, sub-embodiments and subsidiary embodiments of embodiments 5 can be applied to embodiment 6 without conflict.

The first node U3 receives a second information block and a third information block in step S30.

the second node N4 transmits a second information block and a third information block in step S40.

In embodiment 6, the second information block is used to indicate QCL parameters corresponding to a PDCCH QCL indication of the first control resource set, and the third information block is used to indicate QCL parameters corresponding to a PDCCH QCL indication of the second CORESET.

In one embodiment, the second information block is transmitted through an RRC signaling.

In one subembodiment of the embodiment, an RRC signaling for transmitting the second information block comprises an ControlResourceSet IE.

In one subembodiment of the embodiment, an RRC signaling for transmitting the second information block comprises a tci-StatesPDCCH-ToAddList field.

In one subembodiment of the embodiment, a name of an RRC signaling for transmitting the second information block comprises ControlResourceSet.

In one subembodiment of the embodiment, a name of an RRC signaling for transmitting the second information block comprises CORESET.

In one subembodiment of the embodiment, a name of an RRC signaling for transmitting the second information block comprises PDCCH.

In one subembodiment of the embodiment, a name of an RRC signaling for transmitting the second information block comprises TCI.

In one embodiment, the second information block is transmitted through a MAC CE.

In one subembodiment of the embodiment, a MAC CE for transmitting the second information block comprises Indication of TCI state for UE-specific PDCCH.

In one subembodiment of the embodiment, a name of the MAC CE for transmitting the second information block comprises TCI state.

In one subembodiment of the embodiment, a name of a MAC CE for transmitting the second information block comprises PDCCH.

In one embodiment, the third information block is transmitted through an RRC signaling.

In one subembodiment of the embodiment, an RRC signaling for transmitting the third information block comprises a ControlResourceSet IE.

In one subembodiment of the embodiment, an RRC signaling for transmitting the third information block comprises a tci-StatesPDCCH-ToAddList field.

In one subembodiment of the embodiment, a name of an RRC signaling for transmitting the third information block comprises ControlResourceSet.

In one subembodiment of the embodiment, a name of an RRC signaling for transmitting the third information block comprises CORESET.

In one subembodiment of the embodiment, a name of an RRC signaling for transmitting the third information block comprises PDCCH.

In one subembodiment of the embodiment, a name of an RRC signaling for transmitting the third information block comprises TCI.

In one embodiment, the third information block is transmitted through a MAC CE.

In one subembodiment of the embodiment, a MAC CE for transmitting the third information block comprises Indication of TCI state for UE-specific PDCCH.

In one subembodiment of the embodiment, a name of a MAC CE for transmitting the third information block comprises TCI state.

In one subembodiment of the embodiment, a name of a MAC CE for transmitting the third information block comprises PDCCH.

In one embodiment, the second information block and the third information block belong to an RRC signaling.

In one embodiment, the step S30 is taken before step S10 in Embodiment 5.

In one embodiment, the step S30 is taken after the step S10 and before the step S11 in embodiment 5.

In one embodiment, the step S40 is taken before step S20 in Embodiment 5.

In one embodiment, the step S40 is taken after the step S20 and before the step S21 in embodiment 5.

### Embodiment 7

Embodiment 7 illustrates a schematic diagram of a first signaling and a first signal, as shown in FIG. 7. In FIG. 7, a starting time of the first signaling in time domain is not later than a starting time of the first signal in time domain.

In one embodiment, the first signaling and the first signal belong to a same slot in time domain.

In one embodiment, the first signaling and the first signal respectively belong to two different slots in time domain, and a slot where the first signaling is located is earlier than a slot where the first signal is located.

In one embodiment, the first time offset is a time offset between a starting time for transmitting the first signaling and a start time for transmitting the first signal.

In one embodiment, the first time offset is a time offset between an end time for transmitting the first signaling and a start time for transmitting the first signal.

In one embodiment, the first time offset is a difference obtained by subtracting an index of a slot in which the first signaling is located from an index of a slot in which the first signal is located.

In one embodiment, the first time offset is a difference obtained by subtracting an index of a last one of multicarrier symbols where the first signal is located from an index of a first one of multicarrier symbols where the first signaling is located.

In one embodiment, the first time offset is a difference obtained by subtracting an index of a first one of multicarrier symbols where the first signaling is located from an index of a first one of multicarrier symbols where the first signal is located.

### Embodiment 8

Embodiment 8 illustrates a schematic diagram of a first time-domain resource pool, as shown in FIG. 8. In FIG. 8, the first time-domain resource pool comprises K1 time units in time domain, where K1 is a positive integer greater than 1.

In one embodiment, the K1 time units are respectively K1 slots.

In one embodiment, the K1 time units are respectively K1 mini-slots.

In one embodiment, the K1 time units are respectively K1 sub-slots.

In one embodiment, the K1 time units are respectively K1 subframes.

In one embodiment, the K1 time units are respectively K1 radio frames.

In one embodiment, there at least exist two time units in the K1 time units being discontinuous.

In one embodiment, there at least exist two time units in the K1 time units being continuous.

In one embodiment, the K1 time units are periodically distributed in time domain.

In one embodiment, the K1 time units are periodically configured in time domain.

### Embodiment 9

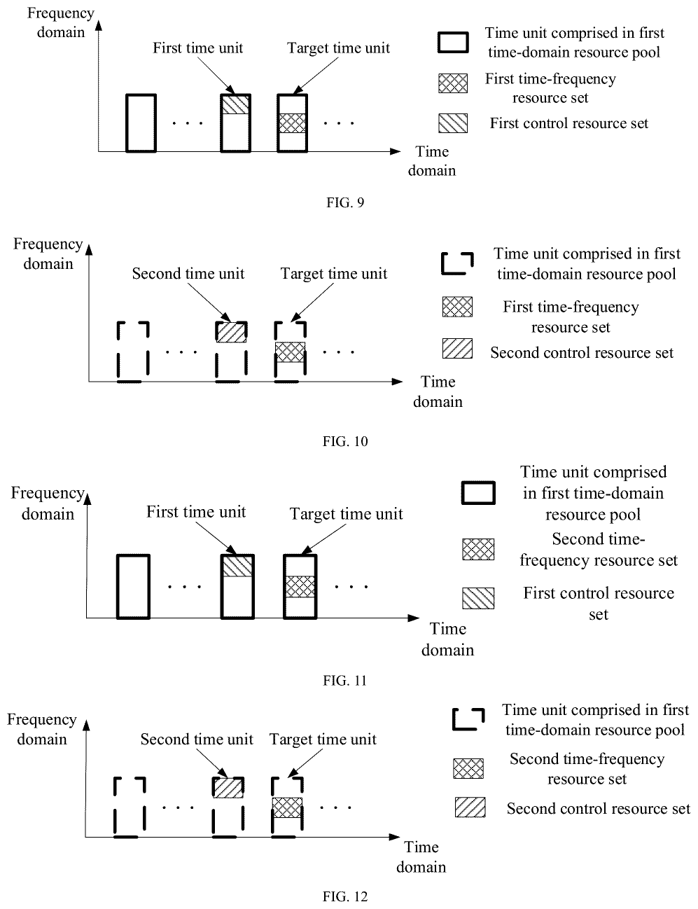

Embodiment 9 illustrates a flowchart of a first control resource set, as shown in FIG. 9. In FIG. 9, the rectangle annotated by the thick and solid wireframe in the figure is a time unit comprised in the first time-domain resource pool; a time unit occupied by the first time-frequency resource set is a target time unit, the first control resource set is located in the first time unit, and the first time unit is a time unit closest to the target time unit in time domain in the first time-domain resource pool.

In one embodiment, the target time unit comprises Q1 CORESETs, with Q1 greater than 1, any CORESET in Q1 CORESETs is associated with a search space, and the first control resource set is a CORESET with a smallest ControlResourceSetId in the Q1 CORESETs.

In one embodiment, the first node is at least configured with a serving cell in the target time unit, and at least one BWP comprised in the serving cell comprises the Q1 CORESETs.

### Embodiment 10

Embodiment 10 illustrates a flowchart of a second control resource set, as shown in FIG. 10. In FIG. 10, the rectangle annotated by the thick and dashed wireframe in the figure is a time unit outside the first time-domain resource pool; a time unit occupied by the first time-frequency resource set is a target time unit, the second CORESET is located in the second time unit, and the second time unit is a time unit closest to the target time unit in time domain outside the first time-domain resource pool.

In one embodiment, the target time unit comprises Q2 CORESETs, with Q2 greater than 1, any CORESET in Q2 CORESETs is associated with a search space, and the second CORESET is a CORESET with a smallest ControlResourceSetId in the Q2 CORESETs.

In one embodiment, the first node is at least configured with a serving cell is configured in the target time unit, and at least one BWP comprised in the serving cell comprises the Q2 CORESETs.

### Embodiment 11

Embodiment 11 illustrates a flowchart of a first control resource set, as shown in FIG. 11. In FIG. 11, the rectangle annotated by the thick and solid wireframe in the figure is a time unit comprised in the first time-domain resource pool; a time unit occupied by the second time-frequency resource set is a target time unit, the first control resource set is located in the first time unit, and the first time unit is a time unit closest to the target time unit in time domain in the first time-domain resource pool.

In one embodiment, the target time unit comprises Q1 CORESETs, with Q1 greater than 1, any CORESET in Q1 CORESETs is associated with a search space, and the first control resource set is a CORESET with a smallest ControlResourceSetId in the Q1 CORESETs.

In one embodiment, the first node is at least configured with a serving cell in the target time unit, and at least one BWP comprised in the serving cell comprises the Q1 CORESETs.

### Embodiment 12

Embodiment 12 illustrates a flowchart of a second control resource set, as shown in FIG. 12. In FIG. 12, rectangle annotated by the thick and solid wireframe in the figure is a time unit outside the first time-domain resource pool; a time unit occupied by the second time-frequency resource set is a target time unit, the second CORESET is located in the second time unit, and the second time unit is a time unit closest to the target time unit in time domain outside the first time-domain resource pool.

In one embodiment, the target time unit comprises Q2 CORESETs, with Q2 greater than 1, any CORESET in Q2 CORESETs is associated with a search space, and the second CORESET is a CORESET with a smallest ControlResourceSetId in the Q2 CORESETs.

In one embodiment, the first node is at least configured with a serving cell in the target time unit, and at least one BWP comprised in the serving cell comprises the Q2 CORESETs.

### Embodiment 13

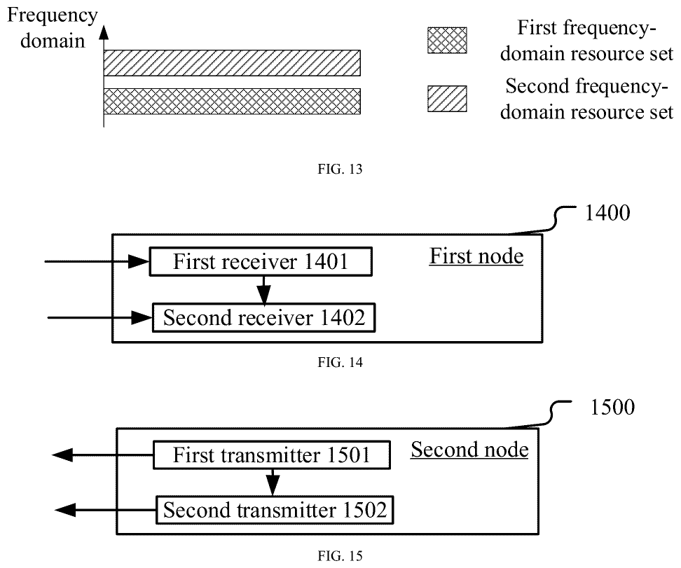

Embodiment 13 illustrates a schematic diagram of a first frequency-domain resource set and a second frequency-domain resource, as shown in FIG. 13. In FIG. 13, frequency-domain resources occupied by the first frequency-domain resource set and frequency-domain resources occupied by the second frequency-domain resource set are orthogonal.

In one embodiment, the first frequency-domain resource set is configured through an RRC signaling.

In one embodiment, the first frequency-domain resource set is indicated through a MAC CE.

In one embodiment, the second frequency-domain resource set is configured through an RRC signaling.

In one embodiment, the second frequency-domain resource set is indicated through a MAC CE.

In one embodiment, the second frequency-domain resource set is dynamically indicated through a physical-layer signaling.

In one embodiment, the second frequency-domain resource set is dynamically indicated through a physical-layer signaling.

In one embodiment, the first frequency-domain resource set occupies frequency-domain resources corresponding to a positive integer number of RB(s) (Resource Block(s)) in frequency domain.

In one embodiment, the second frequency-domain resource set occupies frequency-domain resources corresponding to a positive integer number of RB(s) in frequency domain.

In one embodiment, the first frequency-domain resource set occupies more than one positive integer number of subcarriers in frequency domain.

In one embodiment, the second frequency-domain resource set occupies more than one positive integer number of subcarriers o in frequency domain.

### Embodiment 14

Embodiment 14 illustrates a structure block diagram in a first node, as shown in FIG. 14. In FIG. 14, the first node 1400 comprises a first receiver 1401 and a second receiver 1402.

The first receiver 1401 receives a first information block;
the second receiver 1402 receives a first signaling in a first time-frequency resource set, and receives a first signal in a second time-frequency resource set;

in embodiment 14, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

In one embodiment, the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

In one embodiment, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

In one embodiment, the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

In one embodiment, a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

In one embodiment, the first receiver 1401 receives a second information block and a third information block, the second information block is used to indicate QCL parameters corresponding to a PDCCH QCL indication of the first control resource set, and the third information block is used to indicate QCL parameters corresponding to a PDCCH QCL indication of the second CORESET.

In one embodiment, frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

In one embodiment, the first receiver 1401 comprises at least first four of the antenna 452, the receiver 454, the multi-antenna receiving processor 458, the receiving processor 456 and the controller/processor 459 in Embodiment 4.

In one embodiment, the second receiver 1402 comprises at least first four of the antenna 452, the receiver 454, the multi-antenna receiving processor 458, the receiving processor 456 and the controller/processor 459 in Embodiment 4.

### Embodiment 15

Embodiment 15 illustrates a structure block diagram of a second node, as shown in FIG. 15. In FIG. 15, the second node 1500 comprises a first transmitter 1501 and a second transmitter 1502.

The first transmitter 1501 transmits a first information block;
the second transmitter 1502 transmits a first signaling in a first time-frequency resource set, and transmits a first signal in a second time-frequency resource set;

In embodiment 15, the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

In one embodiment, a receiver of the first information block comprises a first node; the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

In one embodiment, a receiver of the first information block comprises a first node; the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

In one embodiment, a receiver of the first information block comprises a first node; the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

In one embodiment, a receiver of the first information block comprises a first node; the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

In one embodiment, a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

In one embodiment, the first transmitter 1501 transmits a second information block and a third information block; the second information block is used to indicate QCL parameters corresponding to a PDCCH QCL indication of the first control resource set, and the third information block is used to indicate QCL parameters corresponding to a PDCCH QCL indication of the second CORESET.

In one embodiment, frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

In one embodiment, the first transmitter 1501 comprises at least first four of the antenna 420, the transmitter 418, the multi-antenna transmitting processor 471, the transmitting processor 414 and the controller/processor 475 in embodiment 4.

In one embodiment, the second transmitter 1502 comprises at least first four of the antenna 420, the transmitter 418, the multi-antenna transmitting processor 471, the transmitting processor 414 and the controller/processor 475 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block; and
a second receiver, receiving a first signaling in a first time-frequency resource set, receiving a first signal in a second time-frequency resource set;
wherein the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed (Quasi Co-Located) with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

2. The first node according to claim 1, wherein the first node monitors one or multiple CORESETs (Control Resource Sets) in an active BWP (Bandwidth Part) of a serving cell it monitors; the first time offset is less than the first threshold; when time-domain resources occupied by the first time-frequency resource set belong to the first time-domain resource pool, the second reference signal resource is related to QCL parameters of a PDCCH (Physical Downlink Control Channel) QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

3. The first node according to claim 1, wherein the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

4. The first node according to claim 1, wherein the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

5. The first node according to claim 1, wherein the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

6. The first node according to claim 1, wherein a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

7. The first node according to claim 2, wherein the first receiver receives a second information block and a third information block, the second information block is used to indicate QCL parameters corresponding to a PDCCH QCL indication of the first control resource set, and the third information block is used to indicate QCL parameters corresponding to a PDCCH QCL indication of the second CORESET.

8. The first node according to claim 2, wherein frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

9. A second node for wireless communications, comprising:
a first transmitter, transmitting a first information block; and
a second transmitter, transmitting a first signaling in a first time-frequency resource set, and transmitting a first signal in a second time-frequency resource set;
wherein the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

10. The second node according to claim 9, wherein a receiver of the first information block comprises a first node, and the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

11. The second node according to claim 9, wherein a receiver of the first information block comprises a first node, and the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

12. The second node according to claim 9, wherein a receiver of the first information block comprises a first node, and the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.

13. The second node according to claim 9, wherein a receiver of the first information block comprises a first node, and the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain.

14. The second node according to claim 9, wherein a slot format adopted by a symbol occupied by the first time-domain resource pool in time domain is a first format, and time-domain resources corresponding to the first format support dynamic adjustment of uplink and downlink transmission directions, or time-domain resources corresponding to the first format support full duplex transmission.

15. The second node according to claim 10, wherein the first transmitter transmits a second information block and a third information block, the second information block is used to indicate QCL parameters corresponding to a PDCCH QCL indication of the first control resource set, and the third information block is used to indicate QCL parameters corresponding to a PDCCH QCL indication of the second CORESET.

16. The second node according to claim 10, wherein frequency-domain resources occupied by the first control resource set belong to a first frequency-domain resource set, and frequency-domain resources occupied by the second CORESET belong to a second frequency-domain resource set; the first frequency-domain resource set supports dynamic adjustment of uplink and downlink transmission directions, or the first frequency-domain resource set supports full duplex transmission; the second frequency-domain resource set does not support dynamic adjustment of uplink and downlink transmission directions, or the second frequency-domain resource set does not support full duplex transmission.

17. A method in a first node for wireless communications, comprising:
receiving a first information block; and
receiving a first signaling in a first time-frequency resource set, and receiving a first signal in a second time-frequency resource set;
wherein the first information block is used to determine a first time-domain resource pool; the first signaling is used to determine at least one of frequency-domain resources or time-domain resources occupied by the second time-frequency resource set; the first signaling comprises a first field, and the first field in the first signaling is used to determine a first reference signal resource; a time offset between the first signaling and the first signal is a first time offset; when the first time offset is not less than a first threshold, a demodulation reference signal of a channel occupied by the first signal is QCLed with the first reference signal resource; when the first time offset is less than a first threshold, a demodulation reference signal of a channel occupied by the first signal is QCLed with a second reference signal resource, whether time-domain resources occupied by the first time-frequency resource set belong to the first time-domain resource pool or whether time-domain resources occupied by the second time-frequency resource set belong to the first time-domain resource pool is used to determine the second reference signal resource.

18. The method in a first node according to claim 17, wherein the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is time unit comprising one or multiple CORESETs monitored by the first node in an active BWP of a serving cell and being a time unit closest in time domain to the first signal outside the first time-domain resource pool.

19. The method in a first node according to claim 17, wherein the first node monitors one or multiple CORESETs in an active BWP of a serving cell it monitors; the first time offset is less than the first threshold; when time-domain resources occupied by the first time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit comprising one or multiple CORESETs monitored by the first node in an active BWP of a serving cell and being closest in time domain to the first signal in the first time-domain resource pool; when time-domain resources occupied by the first time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, the second time unit is a time unit comprising one or multiple CORESETs monitored by the first node in an active BWP of a serving cell and being a time unit closest in time domain to the first signal.

20. The method in a first node according to claim 17, wherein the first node monitors one or multiple CORESETs in an active BWP of a serving cell it monitors; the first time offset is less than the first threshold; when time-domain resources occupied by the second time-frequency resource set belong to the first time-domain resource pool, the second reference signal resource is related to QCL parameters of a PDCCH QCL indication used for a first control resource set, the first CORESET is a lowest-indexed CORESET associated with a monitored search space in a first time unit, and the first time unit is a time unit closest to the first signal in time domain in the first time-domain resource pool; when time-domain resources occupied by the second time-frequency resource set do not belong to the first time-domain resource pool, the second reference signal resource is related to QCL parameters of a PDCCH QCL indication used for a second control resource set, the second CORESET is a lowest-indexed CORESET associated with a monitored search space in a second time unit, and the second time unit is a time unit closest to the first signal in time domain outside the first time-domain resource pool.
